(19) United States
(12) Patent Application Publication
(10) Pub. No.: US 2025/0263564 A1
(43) Pub. Date: Aug. 21, 2025

(54) WOOD RESTORATION FORMULA AND METHOD THEREOF

(71) Applicant: Mike Macmaster, Gananoque (CA)

(72) Inventor: Mike Macmaster, Gananoque (CA)

(21) Appl. No.: 19/057,348

(22) Filed: Feb. 19, 2025

(30) Foreign Application Priority Data
Feb. 20, 2024 (CA) 3229625

(51) Int. Cl. C09D 9/00

(52) U.S. Cl. CPC C09D 9/005

(57) ABSTRACT

A wood restoration formula and method wherein the method of the present invention is operable to produce a formulation that is configured to provide cleaning wood surfaces. The formulation of the present invention is configured to be non-hazardous. The method of the present invention in a preferred embodiment produces five gallons. The method of the present invention includes the step of adding sodium hydroxide to a volume of water that is approximately half of the total volume to be produced. Additional steps including adding components such as glycol ether and monoethanolamine. The viscosity of the mixture of the formulation is increased through the addition of hydroxyethylcellulose. The mixture includes a step of resting and is further executed at a temperature of at least ten degrees Celsius. Ensuing resting of the mixture a final volume of water is added to bring the mixture volume to five gallons.

### FIELD OF THE INVENTION

The present invention relates generally to surface cleaning products, more specifically but not by way of limitation, a wood stain remover formulation that is operable to facilitate cleaning and restoration of outdoor wood products such as but not limited to decks and fences.

### BACKGROUND

Wood is one of the most common material utilized for construction. Wood is utilized in many areas of construction ranging from but not limited to areas such as wall framing, exterior walls, trusses, fences and decks. Wood is provided in various sizes and type with exterior wood commonly being referred to as treated lumber. Treated lumber is often utilized to build objects such as decks and fences which are exposed to environmental conditions.

Wood that is exposed to environmental conditions will be subjected to wear such as but not limited to mildew growth, dirt and fungus. It is desirable for aesthetic reasons to routinely clean the exterior surface of wooden decks, fences and other exterior structures. Typically, exterior cleaning of wood surfaces employs the use of harsh chemicals that are hazardous to adjacent plant life and further can contaminate the soil as commercially available products do not break down. These chemicals are typically applied to the surface and subsequently rinsed with a pressure washer which only increases the distribution of the hazardous chemicals.

Accordingly, there is a need for a wood restoration formulation that is configured to be applied to the exterior surface of wood wherein the present invention is non-hazardous and breaks down to salts subsequent the use thereof.

### SUMMARY OF THE INVENTION

It is the object of the present invention to provide a wood restoration formulation that is employed to provide cleaning of the exterior surface of wood wherein the present invention includes in the formulation thereof sodium hydroxide.

Another object of the present invention is to provide a method of making a wood restoration formulation wherein the method of the present invention includes the addition of glycol ether to the mixture.

A further object of the present invention is to provide a wood restoration formulation that is employed to provide cleaning of the exterior surface of wood wherein the method of the present invention includes the step of adding monoethanolamine to the mixture.

Yet a further object of the present invention is to provide a method of making a wood restoration formulation wherein the present invention includes the step of adding hydroxyethylcelluose to the mixture.

Still another object of the present invention is to provide a wood restoration formulation that is employed to provide cleaning of the exterior surface of wood wherein the method of the present invention includes a step of resting the mixture for thirty minutes.

An additional object of the present invention is to provide a method of making a wood restoration formulation wherein the formulation of the present invention includes water.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of the method of the present invention.

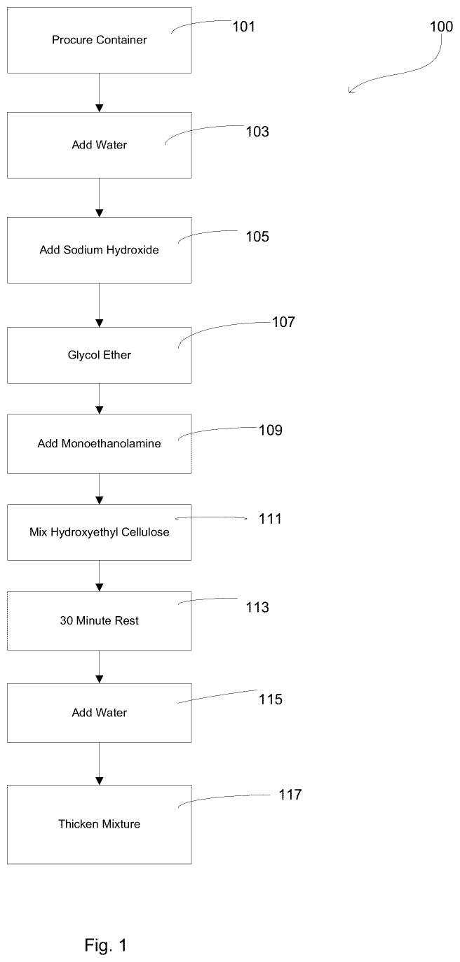

### DETAILED DESCRIPTION

Referring now to the drawings submitted herewith, wherein various elements depicted therein are not necessarily drawn to scale and wherein through the views and figures like elements are referenced with identical reference numerals, there is illustrated wood restoration formula and method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the wood restoration formula and method 100 in its preferred embodiment is provided in a liquid form. While it is contemplated that the present invention could be provided in various quantities, in a preferred embodiment discussed herein the volume of the wood restoration formula is five gallons. In step 101, a user of the method of the present invention selects and procures a suitable container wherein the preferred size container is a five gallon container. Step 103, the user will add approximately two and a half gallons to the container. In step 105, sodium hydroxide is added to the container. In a preferred embodiment of the present invention, three pounds of sodium hydroxide is added to the container. It should be understood within the scope of the present invention that alternate quantities being less than or more than three pounds of sodium hydroxide could be utilized.

In step 107, six cups of glycol ether are added to the container. It is contemplated within the scope of the present invention that alternate amounts of glycol ether could be utilized. Step 109, approximately four cups of monoethanolamine is added to the container. While four cups of monoethanolamine is preferred, it is contemplated within the scope of the present invention that the alternate volumes could be utilized. In step 111, approximately one half cup of a thickening agent is added to the container. While various thickening agents could be utilized, in a preferred embodiment of the present invention hydroxyethylcellulose is utilized to thicken the mixture. The viscosity of the mixture of the present invention is a preferential parameter and as such the user will increase the viscosity to a desired thickness.

Step 113, ensuing addition of the thickener, the mixture will rest in the container for approximately thirty minutes. During the rest and mixing of the formulation of the present invention, the container is placed in an environment having a temperature of at least ten degrees Celsius. In step 115, the user will add additional water to the container wherein the water is added to bring the total amount of the mixture of the formulation of the present invention to be five gallons. Step 117, if desired, additional thickener can be added if the user of the wood restoration formula and method 100 desires to increase the viscosity of the formulation of the present invention.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A wood restoration formulation manufactured utilizing a method comprising steps of:
procuring a container, wherein the container is configured to receive and retain a desired total volume for the wood restoration formulation;
placing a volume of water into the container, wherein the volume of water is equivalent to one half of a volume capacity of the container;
adding sodium hydroxide to the container, wherein three pounds of sodium hydroxide are added to the container;
placing glycol ether into the container, wherein a volume of six cups of glycol ether are placed into the container;
adding monoethanolamine into the container, wherein four cups of monoethanolamine is added into the container;
mixing in a volume of hydroxyethylcellulose into the container, wherein the hydroxyethylcellulose is operable to increase viscosity of the wood restoration formulation;
resting the wood restoration formulation in the container;
adding an additional volume of water to the container.

2. The wood restoration formulation manufactured utilizing the method as recited in claim 1, and further including a step of adding an additional quantity of hydroxyethylcellulose to increase viscosity of the wood restoration formulation.

3. The wood restoration formulation manufactured utilizing the method as recited in claim 2, wherein the hydroxyethylcellulose is added in an amount of one half cup.

4. The wood restoration formulation manufactured utilizing the method as recited in claim 3, wherein the step of resting the wood restoration formulation in the container is performed for thirty minutes.

5. The wood restoration formulation manufactured utilizing the method as recited in claim 4, wherein the wood restoration formulation has a final volume of five gallons.
